(19) United States
(12) Patent Application Publication
(10) Pub. No.: US 2007/0132137 A1
(43) Pub. Date: Jun. 14, 2007

(54) Method and apparatus for control of plastics tube orientation process

(76) Inventors: Peter Glanville Chapman, New South Wales (AU); James Victor Henwood, New South Wales (AU); George Macovaz, New South Wales (AU); Jyri Jarvenkyla, Hollola (FI)

Correspondence Address: GORDON & JACOBSON, P.C., 60 LONG RIDGE ROAD, SUITE 407, STAMFORD, CT, 06902, US

(21) Appl. No.: 10/552,430

(22) PCT Filed: Apr. 8, 2004
(86) PCT No.: PCT/AU04/00460

§ 371 Date: Jul. 10, 2006

(30) Foreign Application Priority Data
Apr. 8, 2003 (AU) 2003901596

(51) Int. Cl. B29C 47/12

(52) U.S. Cl. 264/177.14

(57) ABSTRACT

A continuous process for producing oriented plastic tube is disclosed having the steps of extrusion (12) of a tube to an initial extruded diameter, temperature conditioning (18), diametrical expansion (20) and cooling (30), characterised by control of the circumferential draw ratio by the step of adjusting the diameter of the extruded tube to an adjusted diameter by means of a variable diameter calibrator (13) located between said extrusion and temperature conditioning steps. A process line for carrying out the invention is also disclosed. Further embodiments of the invention include adjustment of the extruded wall thickness and compensatory adjustment of the adjusted diameter so as to effect a change in final wall thickness with unchanged draw ratio, a process for changing final product diameter and a start-up procedure for the process.

### BACKGROUND OF THE INVENTION

This invention relates to a process and apparatus for the manufacture of oriented plastics tubes, and in particular to the manufacture by a continuous process of tubes which are stretched (drawn) in at least the circumferential direction, and preferably also the axial direction, to orient the material in the direction of stretching and enhance its mechanical properties.

International Patent Application No. WO 90/02644 describes one process for the manufacture of thermoplastics tubes for example for unplasticised polyvinyl chloride (PVC-U) which have a degree of orientation in the circumferential direction that improves properties such as resistance to hoop stresses, and renders the tubes particularly suitable for transmission of water under pressure. The process described in that patent application comprises:

(i) extruding a tube of plastics material;

(ii) temperature conditioning the extruded tube to bring it to a temperature suitable for expansion;

(iii) diametrically expanding the tube by application of an internal pressure to the tube, such pressure being limited at its downstream end by a plug that is inflatable or otherwise expandable to maintain pressure within the expansion zone, and at its upstream end by a plug of fixed diameter; and

(iv) cooling the expanded tube to set the tube in its diametrically expanded configuration as a pipe.

In the process described in WO 90/02644, the amount of axial draw in the final, expanded tube is set by the ratio between the speeds of a first haul-off tractor upstream of the temperature conditioning zone and a second haul-off tractor downstream of the expansion zone. The amount of circumferential draw introduced by the diametrical expansion, step (iii) above, is fixed by the ratio of the final pipe mid-wall circumference to the mid-wall circumference of the extruded tube. The mid-wall circumference is the circumference of a right cross-section of the pipe or extruded tube at the centre of the wall thickness.

In general the diametrical draw ratio is sensibly equal to the circumferential draw ratio. Throughout this specification, references to changes in diameter and resultant diametrical draw ratio may be taken to result in an equivalent circumferential draw ratio.

### SUMMARY OF THE INVENTION

The present invention aims to provide a new method and apparatus for control and adjustment of the oriented tube production process and of the properties of the oriented tube produced.

In a first form, the invention provides a continuous process for producing oriented plastic tube comprising the steps of extrusion of a tube to an initial extruded diameter, temperature conditioning, diametrical expansion and cooling, characterised in that the process further includes the step of adjusting the diameter of the extruded tube to an adjusted diameter by means of a variable diameter calibrator located between said extrusion and temperature conditioning steps to control a circumferential draw ratio of said oriented tube produced.

In one preferred form, the invention provides a continuous process for producing oriented plastic tube comprising the steps of extrusion of a tube to an initial extruded diameter and initial wall thickness, adjusting the diameter of the extruded tube to a first adjusted diameter by means of a variable diameter calibrator, temperature conditioning, diametrical expansion and cooling to produce oriented tube having a first circumferential draw ratio, and varying the adjusted diameter set by the variable diameter calibrator while said extrusion step continues, so as to produce oriented tube having a second circumferential draw ratio.

A further preferred form of the invention provides a continuous process for producing oriented plastic tube comprising the steps of extrusion of a tube to an initial extruded diameter and initial wall thickness, adjusting the diameter of the extruded tube to a first adjusted diameter by means of a variable diameter calibrator, temperature conditioning, diametrical expansion and cooling to produce oriented tube having a first oriented tube diameter and a first circumferential draw ratio, varying the oriented tube diameter and thickness and making compensatory variation of the adjusted diameter set by the variable diameter calibrator so as to produce oriented tube having a second oriented tube diameter and said first circumferential draw ratio.

A further form of the invention provides a continuous process for producing oriented plastic tube comprising the steps of extrusion of a tube to an initial extruded diameter, adjusting the diameter of the extruded tube to an operating adjusted diameter by means of a variable diameter calibrator, temperature conditioning, diametrical expansion and cooling to produce oriented tube having a circumferential draw ratio, further comprising a process start-up step in which said diametrical expansion step is not performed and said extruded tube is set by the variable diameter calibrator to a start-up adjusted diameter which is greater than said operating adjusted diameter, and subsequently resetting the variable diameter calibrator to said operating adjusted diameter.

Optionally, the process further includes the step of adjusting the extruded tube wall thickness, so as to alter the wall thickness of the oriented tube produced by the continuous process.

In a further preferred form, the invention provides a continuous process for producing oriented plastic tube comprising the steps of extrusion of a tube to an initial extruded diameter and initial wall thickness, adjusting the diameter of the extruded tube to an adjusted diameter by means of a variable diameter calibrator, temperature conditioning, diametrical expansion and cooling to produce oriented tube having a first circumferential draw ratio and a first wall thickness, varying the extruded tube initial wall thickness, and making compensatory variation of the adjusted diameter set by the variable diameter calibrator so as to produce oriented tube having a second wall thickness and said first circumferential draw ratio.

A second form of the invention provides a process line for production of oriented plastic tube, comprising an extruder for extruding a tube to an initial extruded diameter, a variable diameter calibrator for adjusting diameter of the tube following extrusion to an adjusted diameter, temperature conditioning apparatus for bringing the tube to a temperature suitable for expansion, expansion apparatus for causing diametrical expansion of the adjusted diameter tube and cooling means for setting the tube in its diametrically expanded configuration.

### BRIEF DESCRIPTION OF THE DRAWINGS

Further preferred embodiments of the invention will now be described with reference to the accompanying drawings, in which:

FIG. 1 is a schematic representation of a process line for production of oriented plastic tube, in accordance with an embodiment of the invention;

FIG. 2A is a schematic of a first start-up step in operation of the process line of FIG. 1;

FIG. 2B is a schematic of a second start-up step in operation of the process line;

FIG. 2C is a schematic of a third and final start-up step in operation of the process line; and

FIGS. 3A and 3B are schematics illustrating adjustment of the process line of FIG. 1 to alter the diameter or wall thickness of the oriented tube produced

### DETAILED DESCRIPTION OF THE PREFERRED EMBODIMENTS

The figures schematically illustrate a process line for the continuous (ie. ion-line)—as opposed to batch (ie. off-line)—production of thick wall oriented plastics tube, in which the tube undergoes extrusion, temperature conditioning, diametrical expansion and cooling steps as it progresses along the process line.

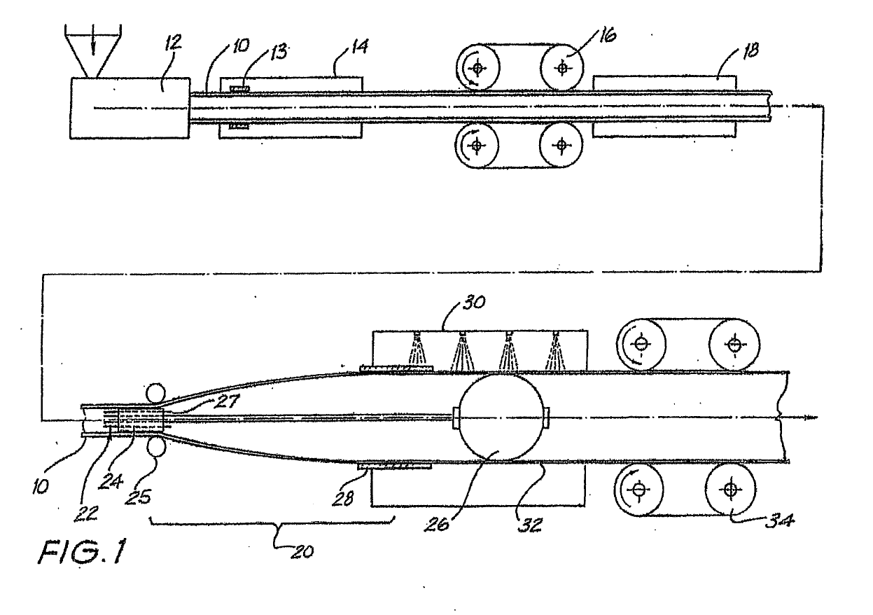

Referring to FIG. 1, the plastic tube 10 is produced continuously by extruder 12 at an extruded diameter and wall thickness. This extruded tube is then reset to an adjusted initial diameter by a variable diameter calibration device, such as a variable diameter sizing sleeve 13, within a primary cooling spray tank 14. In the operation of the invention, this adjusted diameter sets the diameter of the extruded tube during primary cooling which becomes the starting point for determining the circumferential draw to be introduced to the tube.

The tube 10 is hauled from the extruder by a first haul-off tractor 16.

The tube 10 then proceeds to a temperature conditioning zone 18, in which the tube is contacted with a heat transfer medium such as water to attain a specific temperature profile across the tube wall, at which the subsequent diametrical expansion of the tube causes orientation of the polymer molecules principally in the circumferential direction. The tube then enters an expansion zone 20 between a pair of plugs 24 and 26 held inside the tube by a service tube 22 connected back through the extruder head to a thrust restraint (not shown).

The first plug 24—the upstream plug relative to the direction of travel of the tube 10—is sized to fit tightly within the unexpanded tube 10. A series of control wheels 25 surrounding the tube circumference push the tube tightly on to the plug 24 so that there is sufficient seal to maintain pressure in the expansion zone.

Optionally, the control wheels 25 may be driven to dictate the velocity at which the tube is fed into the expansion zone.

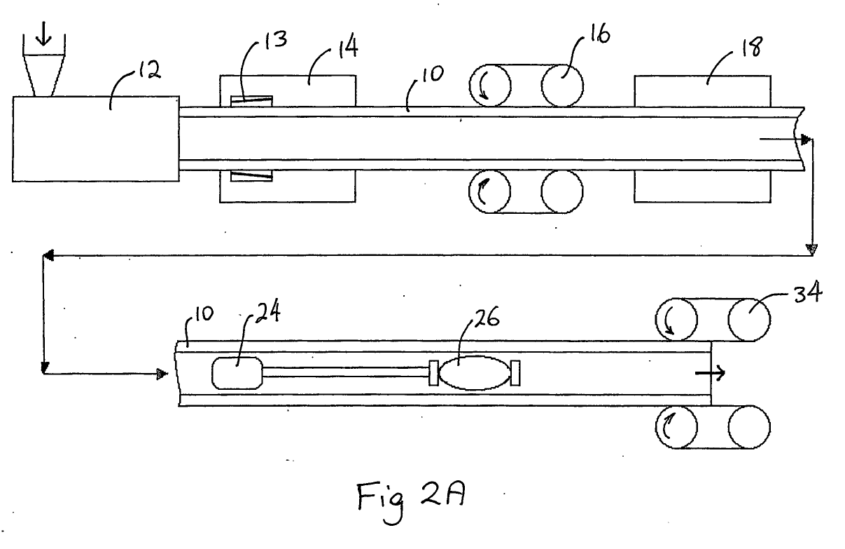

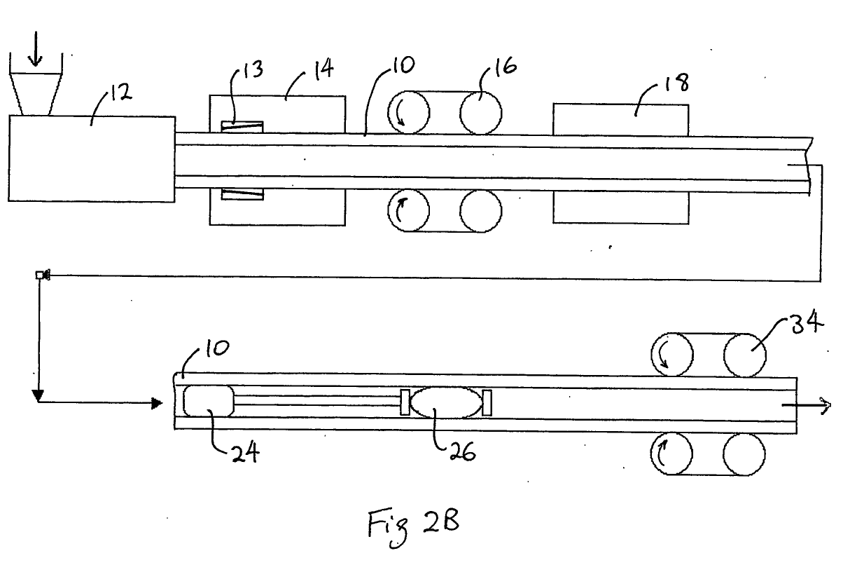

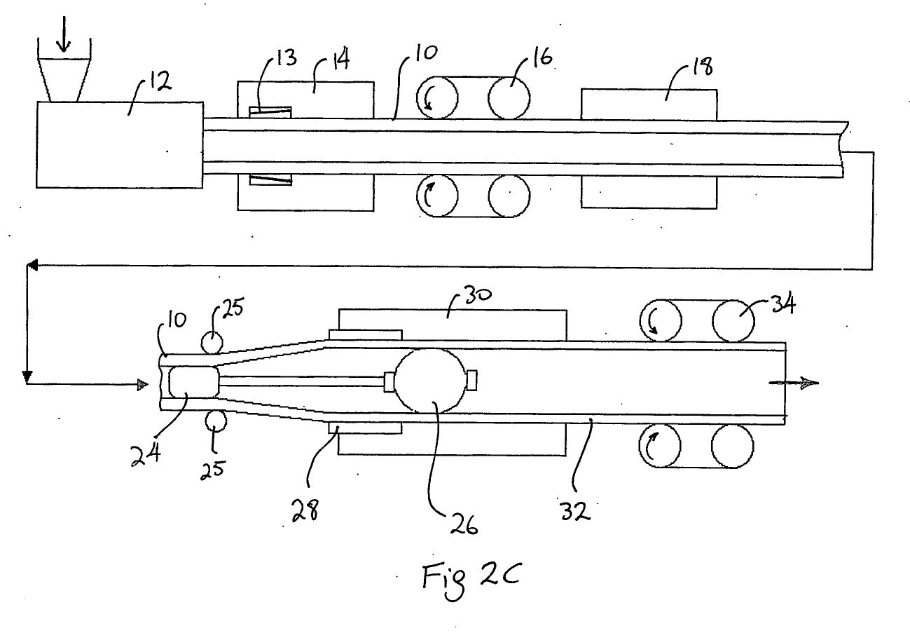

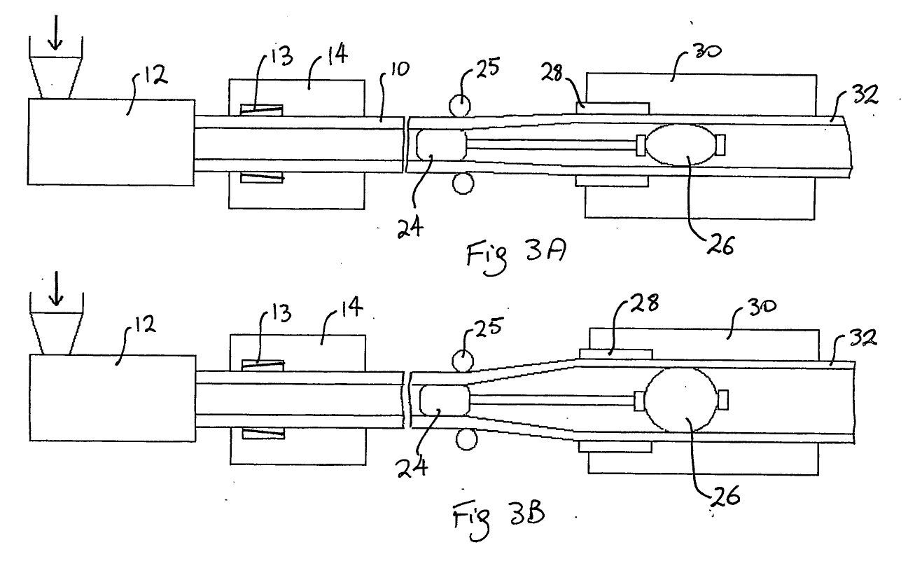

The downstream plug 26 is inflatable so that its diameter can be changed from the unexpanded state to the expanded state in order to start the process, as will be described below with reference to FIGS. 2A to 2C. The degree of inflation can be controlled to adjust the diameter of the expanded tube, as will be described below with reference to FIGS. 3A and 3B.

In steady state operation of the process, the plug 26 is inflated sufficiently to maintain pressure in the expansion zone while allowing some of the expansion fluid to flow past the plug and lubricate the plug within the moving tube. The service tube 22 has a pair of internal tubes which may be concentric tubes, one of which continues forward to carry inflation fluid, for example air, to the downstream plug 26 and the other supplying expansion fluid, preferably hot water, to the upstream plug, which then enters the expansion zone via outlets 27.

Between the two plugs the plastic tube 10 undergoes expansion in the radial direction due to the internal pressure, without external restraint. Towards the downstream end of the expansion zone, there is provided a sizing sleeve 28 or other sizing device and a cooling spray tank 30 for setting the final external diameter of the expanded tube 32. This is followed by a final haul-off tractor 34, which is set at a higher speed than the first haul-off 16, and cutting equipment (not shown).

The average axial draw of the tube over the whole process line is fixed by ratios of the first and final haul-off tractor speeds. Axial draw may be introduced both in the expansion zone itself and in the pre-expansion zone between the first haul-off 16 and the driven wheels 25. Essentially no axial draw is introduced after the expansion zone as the tube has been cooled. Thus, at any time the sum of the axial draw being introduced in the expansion and pre-expansion zones will be equal to the haul-off ratios between the first and final tractors and therefore constant.

The average wall thickness of the final oriented tube may be controlled by controlling the speed of the final haul-off tractor 34.

The average degree of circumferential draw introduced to the tube is determined by the ratio of the mid-wall diameter of the final oriented tube 32 to the mid-wall diameter of the unexpanded tube 10. The inventors have found that this starting point is not the mid-wall diameter at initial extrusion as previously believed in the art, but is the diameter at initial calibration, and that by adjusting the calibrated diameter of the extruded tube before the primary cooling 14 it is possible to adjust the circumferential draw ratio of the final product.

Variable calibrators of the type suitable for use in extrusion lines are known per se for control of the final diameter in the production of unoriented plastics tube, and typically are capable of up to a few percent variation in the calibrated diameter of the tube, depending on the tube material. Variable calibrators are described in EP 1 048 434 and WO 96/36475. The first referenced is commercially available from ConPro GmbH of Germany. In general these calibrators are limited to a small adjustment range suitable for wear and shrinkage compensation. Larger changes as would be suitable for size changes are not possible without producing unacceptable distortion of the outside circumference. However, variable calibrators of higher diameter variation can be used for the orientation process of the present invention, even with some distortion of shape, as the initially calibrated tube will undergo expansion and sizing to its final expanded diameter.

Further advantages of the invention in operation of the process are apparent from FIGS. 2A to 2C, which schematically illustrate a preferred start-up sequence for the process line of FIG. 1.

FIG. 2A shows a first step in start-up of the process line, in which the extruder head is started, but no diametrical expansion is carried out. In this step, the downstream expansion plug 36 is deflated to its minimum diameter. The variable diameter calibrator 13 is adjusted to a produce an adjusted tube diameter sufficiently large for the tube to pass readily over the upstream plug and the deflated downstream plug. Control wheels 25 are moved outwards of their operating positions to provide clearance for the larger diameter calibrated extruded tube to pass the upstream plug 24. Once the leading end of the tube passes through the expansion zone, the downstream haul-off 34 can be engaged to help pull the tube along the process line.

FIG. 2B shows the next step in the start-up procedure, in which the diameter of the variable diameter calibrator is reduced to the operating diameter, causing the extruded tube to contact the upstream plug as it passes. Control wheels 25 are moved into their operating positions, urging the tube to maintain a seal against the upstream plug 24 as described above with reference to FIG. 1.

The downstream plug 26 is then inflated gradually to its operating pressure and diameter (FIG. 2C).

By employing a variable calibrator in this way in the start-up of the process line, the leading end of the extruded and calibrated tube may be fed over the expansion zone plugs 24 and 26 with little or no frictional engagement, until the downstream haul-off 34 can be engaged with the tube to assist. This start-up procedure also reduces the risk of wear or damage to the downstream plug which may occur during start-up.

FIGS. 3A and 3B illustrate use of the invention to produce a variation in outside diameter and/or wall thickness of the resultant oriented tube while the process line is operating.

FIG. 3A schematically depicts operation of the process line to produce oriented tube of a first outside diameter and wall thickness.

The circumferential draw ratio of the expanded tube is the ratio of the mid-wall circumference of the tube at the calibrator 13 to the mid-wall circumference of the final tube after expansion and, as discussed above, is essentially equal to the ratio of the corresponding mid-wall diameters.

FIG. 3B shows the process line adjusted to produce tube of a larger diameter without change in the circumferential draw ratio. The change in diameter shown in FIGS. 3A and 3B is exaggerated for illustrative purposes.

The diameter change may be achieved without change in the extruded diameter by adjusting the variable calibrator 13 diameter in proportion to the increase of expanded diameter. Thus, for a typical circumferential draw ratio of 2:1, a 10 mm increase in final diameter of the tube will require approximately a 5 mm increase in the adjusted diameter set by the variable calibrator.

For change of final tube diameter, the final sizing sleeve 28 may be replaced with a sizing sleeve of different diameter during operation of the process. Similarly, the upstream and downstream plugs may be replaced with different diameter plugs if required. If necessary, the tube may be cut off upstream of the expansion zone 20 to allow removal and replacement of components without the need to shut down the extruder. The speeds of the upstream and downstream haul-offs 16, 34 are adjusted relative to the extrusion speed, to control the wall thickness of the final product. The invention thus allows the adjustment in diameter to be made while operation of the process line continues, with only a brief interruption to production during the diameter transition, by variation of the calibrator diameter, rather than an interruption of several hours to shutdown the extruder.

In an unillustrated variation of FIGS. 3A and 3B, the process may also be adjusted on the run to effect a change in the class (wall thickness) of the oriented tube produced, while leaving the final outside diameter and circumferential draw ratio unchanged. In this embodiment, a change in wall thickness will change the mid-wall diameter of the expanded tube, even though the outside diameter is unchanged. In order to compensate for this change, the diameter of the variable calibrator 13 is adjusted to keep the ratio of the mid-wall diameter at the calibrator proportional to the final mid-wall diameter.

For example, a 4 mm increase in wall thickness of the finished tube will decrease the mid-wall diameter by 4 mm. To maintain a circumferential draw ratio of 2:1, the variable calibrator 13 is adjusted to decrease the adjusted diameter of the unexpanded tube by 2 mm. The seal between the adjusted diameter tube and the seals on the outer surface of the upstream expansion plug 24 is maintained despite the resultant adjustment of the internal diameter of the tube entering the expansion zone, as the extruded tube stretches down in diameter upstream of the expansion zone and stretches up over the plug 24. Furthermore, the extruded tube is pushed onto the plug by the control wheels 25.

It will be appreciated that, while the embodiments of the invention are described with reference to a process line using an inflatable plug expansion means, the benefits of the invention will apply also to solid mandrel (of fixed or variable diameter types) or other diametrical expansion means and the present invention applies also to such processes.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, the scope of the invention being indicated by the appended claims rather than the foregoing description, and all changes which come within the meaning and range of equivalency of the claims are therefore intended to be embraced therein. It will further be understood that any reference herein to known prior art does not, unless the contrary indication appears, constitute an admission that such prior art is commonly known by those skilled in the art to which the invention relates.

1. A continuous process for producing oriented plastic tube comprising the steps of extrusion of a tube to an initial extruded diameter, temperature conditioning, diametrical expansion and cooling, characterised in that the process for includes the step of adjusting the diameter of the extruded tube to an adjusted diameter by means of a variable diameter calibrator located between said extrusion and temperature conditioning steps to control a circumferential draw ratio of said oriented tube produced.

2. A process according to claim 1, wherein said diametrical expansion step comprises application of an internal pressure to the tube within an expansion zone.

3. A process according to claim 2, wherein said internal pressure is limited at a downstream end by an expandable plug to maintain pressure within the expansion zone.

4. A process according to claim 3, wherein said internal pressure is limited at an upstream end by an upstream plug.

5. A continuous process for producing oriented plastic tube comprising the steps of extrusion of a tube to an initial extruded diameter and initial wall thickness, adjusting the diameter of the extruded tube to a first adjusted diameter by means of a variable diameter calibrator, temperature conditioning, diametrical expansion and cooling to produce oriented tube having a first circumferential draw ratio, and varying the adjusted diameter set by the variable diameter calibrator while said extrusion step continues, so as to produce oriented tube having a second circumferential draw ratio.

6. A process according to claim 5, further including the step of adjusting the extruded tube initial wall thickness, so as to alter the wall thickness of the oriented tube produced by the continuous process.

7. A process according to claim 6, wherein said step of adjusting said initial wall thickness comprises varying an upstream haul-off speed of said extruded tube and said step of adjusting said wall thickness of the oriented tube comprises varying a downstream haul-off speed of said oriented tube.

8. A continuous process for producing oriented plastic tube comprising the steps of extrusion of a tube to an initial extruded diameter and initial wall thickness, adjusting the diameter of the extruded tube to an adjusted diameter by means of a variable diameter calibrator, temperature conditioning, diametrical expansion and cooling to produce oriented tube having a first circumferential draw ratio and a first wall thickness, varying the extruded tube initial wall thickness, and making compensatory variation of the adjusted diameter set by the variable diameter calibrator so as to produce oriented tube having a second wall thickness and said first circumferential draw ratio.

9. A process according to claim 8, wherein said step of adjusting said initial wall thickness comprises varying an upstream haul-off speed of said extruded tube and said step of adjusting said wall thickness of the oriented tube comprises varying a downstream haul-off speed of said oriented tube.

10. A continuous process for producing oriented plastic tube comprising the steps of extrusion of a tube to an initial extruded diameter and initial wall thickness, adjusting the diameter of the extruded tube to a first adjusted diameter by means of a variable diameter calibrator, temperature conditioning, diametrical expansion and cooling to produce oriented tube having a first oriented tube diameter and a first circumferential draw ratio, varying the oriented tube diameter and thickness and making compensatory variation of the adjusted diameter set by the variable diameter calibrator so as to produce oriented tube having a second oriented tube diameter and said first circumferential draw ratio.

11. A process according to claim 10, further including the step of adjusting the extruded tube initial wall thickness.

12. A process according to claim 10, further including the step of maintaining continuous extrusion of said tube to said initial extruded diameter while said oriented tube diameter and adjusted diameter are varied.

13. A process according to claim 10, wherein said step of varying the oriented tube diameter comprises replacing a downstream tube sizing apparatus while said extrusion step continues.

14. A process according to claim 13, wherein said step of varying the oriented tube diameter further comprises replacing a diametrical expansion plug causing said diametrical expansion of the tube.

15. A continuous process for producing oriented plastic tube comprising the steps of extrusion of a tube to an initial extruded diameter, adjusting the diameter of the extruded tube to an operating adjusted diameter by means of a variable diameter calibrator, temperature conditioning, diametrical expansion and cooling to produce oriented tube having a circumferential draw ratio, further comprising a process start-up step in which said diametrical expansion step is not performed and said extruded tube is set by the variable diameter calibrator to a start-up adjusted diameter which is greater than said operating adjusted diameter, and subsequently resetting the variable diameter calibrator to said operating adjusted diameter.

16. A process according to claim 15, wherein said diametrical expansion step comprises application of an internal pressure to the tube within an expansion zone limited at a downstream end by an expandable plug to maintain pressure within the expansion zone, and wherein in said start-up step said expandable plug is in an unexpanded state and said start-up adjusted diameter is sufficiently large for the tube to pass over said expandable plug in its unexpanded state.

17. A process according to claim 16, wherein said step of subsequently resetting the variable diameter calibrator to said operating adjusted diameter is performed prior to expanding said expandable plug to cause said diametrical expansion of the tube.

18. A process line for production of oriented plastic tube, comprising an extruder for extruding a tube to an initial extruded diameter, a variable diameter calibrator for adjusting diameter of the tube following extrusion to an adjusted diameter, temperature conditioning apparatus for bringing the tube to a temperature suitable for expansion, expansion apparatus for causing diametrical expansion of the adjusted diameter tube and cooling means for setting the tube in its diametrically expanded configuration.
